(19) United States
(12) Patent Application Publication
(10) Pub. No.: US 2026/0137207 A1
(43) Pub. Date: May 21, 2026

(54) DOOR OPENING AND CLOSING STRUCTURE OF DRAWER TYPE KITCHEN APPLIANCE

(71) Applicant: Guangdong Hyxion Smart Kitchen Co.,Ltd, Dongguan (CN)

(72) Inventors: JINGHUI YANG, Dongguan (CN); LINDE JIANG, Dongguan (CN)

(21) Appl. No.: 19/093,035

(22) Filed: Mar. 27, 2025

(30) Foreign Application Priority Data
Nov. 16, 2024 (CN) 202411638222.6

(51) Int. Cl. A47B 88/457; A47B 88/45; H05B 6/64

(52) U.S. Cl. CPC A47B 88/457; A47B 88/45; H05B 6/6414

(57) ABSTRACT

A door opening and closing structure of a drawer type kitchen appliance is provided, including: a kitchen appliance body, wherein the kitchen appliance body is provided with a drawer door assembly; a drawer movement mechanism that is arranged inside the kitchen appliance body and is connected to the drawer door assembly, wherein the drawer movement mechanism includes a drive module and a transmission module. Consistency and stability of opening and closing doors on the left and right can be achieved, thus ensuring the reliability of a product, avoiding desynchronization and a failure of opening and closing doors, and guaranteeing normal operation of a motor.

### CROSS-REFERENCE TO RELATED APPLICATIONS

This application claims priority to Chinese Patent Application No.

202411638222.6, filed on Nov. 16, 2024, which is hereby incorporated by reference in its entirety.

### TECHNICAL FIELD

The present disclosure relates to the technical field of microwave oven equipment, and in particular, to a door opening and closing structure of a drawer type kitchen appliance.

### BACKGROUND

At present, there are various ways to open or close doors of drawer type kitchen appliances on the market, including a manual way, a semi-automatic way, or a fully automatic way. In automatic door opening and closing, a single-sided motor driving form is used, which means that a drive motor is placed on one sliding rail, and the other one or two sliding rails are driven parts and do not participate in driving. The design of single-sided motor driving means that a drive force only acts on the sliding rail on one side, and the sliding rail on the other side is a driven part. This asymmetric distribution of the drive force may lead to the following problems: 1. After long-term use, due to the concentration of the drive force on one side, a door body may tilt, resulting in unsmooth opening and closing of the door, and even jamming. 2. An active sliding rail bears a higher load, which may accelerate wear to the active sliding rail, and a passive sliding rail may deform or be loosened due to the non-uniform force distribution. 3. The motor needs to provide a sufficient drive force to overcome a weight and a friction force of the door body, but since the drive force only acts on one side, the motor may bear a higher load, and long-term use can easily cause overheating or damage to the motor.

### SUMMARY

The present disclosure aims to overcome the above shortcomings in the prior art, and provides a door opening and closing structure of a drawer type kitchen appliance, which can achieve consistency and stability of opening and closing doors on the left and right, thus ensuring the reliability of a product, avoiding desynchronization and a failure of opening and closing doors, and guaranteeing normal operation of a motor.

In order to achieve the above objectives, the present disclosure provides a door opening and closing structure of a drawer type kitchen appliance, including:
a kitchen appliance body, wherein the kitchen appliance body is provided with a drawer door assembly; and
a drawer movement mechanism that is arranged inside the kitchen appliance body and is connected to the drawer door assembly, wherein the drawer movement mechanism includes a drive module and a transmission module; the transmission module includes a transmission wheel group connected to the drive module, a transmission base fixedly arranged inside the kitchen appliance body, and two groups of synchronization members arranged on the transmission base; the transmission wheel group is connected with a drive rod; two sides of the drive rod are respectively linked with the synchronization members; and two end portions of the drive rod are connected to the drawer door assembly, to drive the drawer door assembly to be opened or closed.

Further, the transmission wheel group includes an active drive assembly, a passive drive assembly, and a synchronous wheel belt configured to connect the active drive assembly to the passive drive assembly; and the active drive assembly includes a first fixed frame fixedly arranged on the transmission base, a main drive gear arranged on one side of the first fixed frame, and a first transmission gear movably arranged inside the first fixed frame.

Further, the first transmission gear and the main drive gear are linked with each other through a first transmission shaft provided; the first fixed frame is further connected with a first fixing member; bearings are arranged on front and rear sides of the first fixing member; and the first transmission shaft links the first transmission gear to the main drive gear through the two bearings.

Further, the first transmission gear is linked to the main drive gear through a first transmission shaft provided; the passive drive assembly includes a second fixed frame fixed on another side of the transmission base away from the active drive assembly, and a driven wheel arranged on the second fixed frame; and the first transmission gear and the driven wheel are linked to each other through the synchronous wheel belt.

Further, the drive module includes a motor fixing frame fixedly connected inside the kitchen appliance body, a drive motor fixed on the motor fixing frame, and a second transmission gear connected to the drive motor; and the second transmission gear is connected to the first transmission gear through a gear belt provided.

Further, a fixing assembly is connected to a middle position of the drive rod, and the fixing assembly is fixedly connected to the synchronous wheel belt.

Further, the fixing assembly includes a second fixing member and a third fixing member; the second fixing member is of a cylindrical structure and sleeves a middle position of the drive rod; concave parts are provided at upper and lower ends of the second fixing member; the third fixing member is of a frame structure; the third fixing member is inserted into the concave parts and is connected to the second fixing member; inwards sunken clamping slots are formed in two ends of the third fixing member; and the clamping slots wrap around the synchronous wheel belt to achieve linkage.

Further, the synchronizer members are synchronizer racks, and synchronizer gears that are meshed with the synchronizer members are arranged on two side positions of the drive rod.

Further, a side wing of the transmission base extends upwards to form a limiting portion; a semicircular arc groove is provided in the limiting portion; and the drive rod passes through the semicircular arc groove and is connected to the drawer door assembly.

Further, the drawer door assembly includes a sliding rail fixedly arranged inside the kitchen appliance body, a sliding rail support frame connected to the sliding rail, and the drawer door connected to the sliding rail support frame.

Further, the door opening and closing structure of the drawer type kitchen appliance includes a connecting piece, wherein threads are formed in two end portions of the drive rod; one end of the connecting piece is connected to the sliding rail support frame; and another end of the connecting piece is connected to an end portion of the drive rod through a bolt.

Further, signal acquisition devices are arranged at two end portions of the semicircular arc groove.

Further, the signal acquisition devices are limiting sensors.

Further, the first fixed frame includes a first carrier frame and a first wrapping member; a first accommodating space for accommodating the first transmission gear is formed on the first carrier frame; first connecting through holes are provided in front and rear ends of the first carrier frame; the first connecting through holes are configured to allow the first transmission shaft to pass through; and the first carrier frame and the first fixing member are mounted inside the first wrapping member, and the first carrier frame, the first fixing member, and the first wrapping member are fixed with screws.

Further, wrapping edges are formed on two sides of the first wrapping member, so that the first wrapping member forms a “C” structure.

Further, a first opening is provided in one side of each first connection through hole.

Further, the second fixed frame includes a first bracket and a second bracket that are vertically fastened to each other, and the first bracket and second bracket form a passage for allowing the passive transmission shaft to pass through after being vertically fastened to each other.

Further, a size of the first bracket is slightly greater than a size of the second bracket.

Further, the first bracket and the second bracket are both provided with two outwards extending connecting edges; hanging holes are provided in the connecting edges; the connecting edge of the first bracket is upwards vertically arranged; and the second bracket is horizontally arranged to wrap around the first bracket, so that the two hanging holes are vertically stacked with each other to form the passage for allowing the passive transmission shaft to pass through.

Compared with the prior art, the present disclosure has the following advantages: In the present disclosure, power for opening or closing the drawer door is provided through the drive module. A force is transferred to the middle part of the drive rod through the transmission wheel group to drive the drive rod to synchronously rotate. The two end portions of the drive rod are connected to the sliding rails of the drawer door, and the two sides of the drive rod are connected with the synchronizer members. By the cooperation between the synchronizer members and the drive rod, the left side and the right side are synchronized to achieve dual drive. The synchronous drive structure can ensure that the drawer door is always kept in horizontal movement in the opening or closing process, thus improving the stability and fluency of operation, ensuring that forces on the two sides of the drawer door are uniform in the opening or closing process, and avoiding the problem of door tilting or jamming caused by single-sided drive. Meanwhile, a drive force of the drive module is uniformly transferred to the synchronizer members on the two sides through the transmission wheel group and the drive rod, which reduces the problem of load concentration in single-sided motor drive, thus prolonging the service lives of the motor and the sliding rails. Furthermore, the synchronous drive structure avoids wear or deformation caused by a non-uniform force on a sliding rail on one side, so that the maintenance costs are reduced. This improves the reliability and stability of equipment, and further optimizes a user experience. It is an efficient and practical drawer door drive solution.

### BRIEF DESCRIPTION OF DRAWINGS

To describe the technical solutions in the embodiments of the present disclosure or in the related art more clearly, the following briefly introduces the accompanying drawings for describing the embodiments or the related art. Apparently, the accompanying drawings in the following description show some embodiments of the present disclosure, and a person of ordinary skill in the art may still derive other drawings from the accompanying drawings without creative efforts.

FIG. 1 is a schematic structural diagram of a door opening and closing structure of a drawer type kitchen appliance according to the present disclosure;

FIG. 2 is a schematic structural diagram of the door opening and closing structure in FIG. 1, without a shell;

FIG. 3 is a schematic structural diagram of a drawer movement mechanism according to the present disclosure;

FIG. 4 is a schematic structural diagram of an active drive assembly according to the present disclosure;

FIG. 5 is a schematic structural diagram of a passive drive assembly according to the present disclosure;

FIG. 6 is an exploded view of a transmission module, a drive rod, and a transmission base according to the present disclosure; and

FIG. 7 is an enlarged view of a region A in FIG. 6.

### IN THE DRAWINGS

1: kitchen appliance body; 2: drawer door assembly; 21: sliding rail; 22: sliding rail support bracket; 23: drawer door; 3: drawer movement mechanism; 31: drive module; 311: motor fixing frame; 312; drive motor; 313: second transmission gear; 314: gear belt; 32: transmission module; 33: transmission wheel group; 331: active drive assembly; 3311: first fixed frame; 33111: first carrier frame; 33112: first wrapping member; 33113: first accommodating space; 33114: first connecting through hole; 33115: wrapping edge; 33116: first opening; 3312: main drive gear; 3313: first transmission gear; 3314: first transmission shaft; 3315: first fixing member; 3316: bearing; 332: passive drive assembly; 3321: second fixed bracket; 33211: first bracket; 33212: second bracket; 33213: connecting edge; 33214: hanging hole; 3322: driven wheel; 3323: passive transmission shaft; 333: synchronous wheel belt; 34; transmission base; 341: limiting portion; 3411: semicircular arc groove; 35: synchronizer member; 36: drive rod; 361: synchronizer gear; 362: fixing assembly; 3621: second fixing member; 36211: concave part; 3622: third fixing member; and 36221: clamping slot.

### DESCRIPTION OF EMBODIMENTS

The technical solutions in the implementations of the present disclosure are clearly and completely described below with reference to the accompanying drawings in the implementations of the present disclosure. Apparently, the described implementations are some rather than all of the embodiments of the present disclosure. All other implementations obtained by a person of ordinary skill in the art based on this implementation of present disclosure without making creative efforts shall fall within the protection scope of present disclosure.

It should be noted that all directional indications (such as up, down, left, right, front, back, . . . ) involved in the embodiments of the present disclosure are only used to explain the relative positional relationship, motion states, and the like between various components in specific postures (as shown in the figures). If the specific postures change, the directional indications also change correspondingly.

In addition, if there are descriptions related to “first”, “second”, and the like in the embodiments of the present disclosure, the descriptions of “first”, “second”, and the like are only used for descriptive purposes and cannot be understood as indicating or implying their relative importance or implying the quantities of indicated technical features.

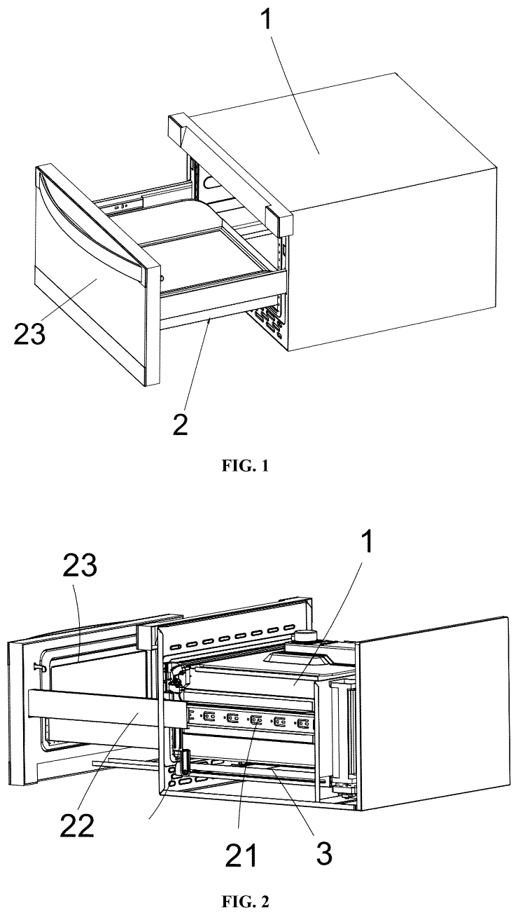

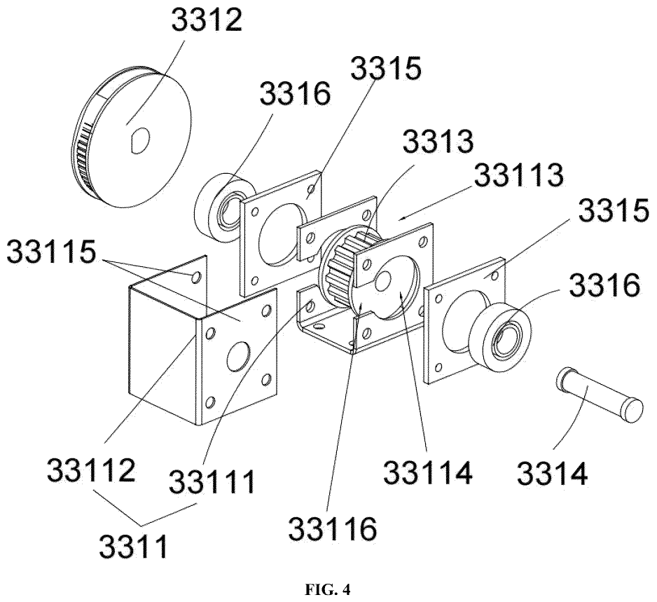

Referring to FIG. 1 to FIG. 7, an embodiment of the present disclosure provides a door opening and closing structure of a drawer type kitchen appliance.

The door opening and closing structure of the drawer type kitchen appliance of this embodiment, as shown in FIG. 1 to FIG. 2, includes:
a kitchen appliance body 1, wherein the kitchen appliance body 1 is provided with a drawer door assembly 2; as shown in FIG. 2, the drawer door assembly 2 includes a sliding rail 21 fixedly arranged inside the kitchen appliance body 1, a sliding rail support frame 22 connected to the sliding rail 21, and a drawer door 23 connected to the sliding rail support frame 22; and
a drawer movement mechanism 3 that is arranged inside the kitchen appliance body 1 and is connected to the drawer door assembly 2. The drawer movement mechanism 3 includes a drive module 31 and a transmission module 32. The transmission module 32 includes a transmission wheel group 33 connected to the drive module 31, a transmission base 34 fixedly arranged inside the kitchen appliance body 1, and two groups of synchronizer members 35 arranged on the transmission base 34. The transmission wheel group 33 is connected with a drive rod 36. Two sides of the drive rod 36 are respectively linked with the synchronizer members 35. Two end portions of the drive rod 36 are connected to the drawer door assembly 2, to drive the drawer door assembly 2 to be opened or closed.

Specifically, as shown in FIG. 2 to FIG. 4, the foregoing transmission wheel group 33 includes an active drive assembly 331, a passive drive assembly 332, and a synchronous wheel belt 333 configured to connect the active drive assembly 331 to the passive drive assembly 332. The active drive assembly 331 includes a first fixed frame 3311 fixedly arranged on the transmission base 34, a main drive gear 3312 arranged on one side of the first fixed frame 3311, and a first transmission gear 3313 movably arranged inside the first fixed frame 3311. The first transmission gear 3313 and the main drive gear 3312 are linked with each other through a first transmission shaft 3314 provided. Further, the first fixed frame 3311 is further connected with a first fixing member 3315. Bearings 3316 are arranged on front and rear sides of the first fixing member 3315. The first transmission shaft 3314 links the first transmission gear 3313 to the main drive gear 3312 through the two bearings.

In a preference, the first fixed frame 3311 includes a first carrier frame 33111 and a first wrapping member 33112. A first accommodating space 33113 for accommodating the first transmission gear 3313 is formed on the first carrier frame 33111. First connecting through holes 33114 are provided in front and rear ends of the first carrier frame 33111. The first connecting through holes 33114 are configured to allow the first transmission shaft 3314 to pass through. Wrapping edges 33115 are formed on two sides of the first wrapping member 33112, so that the first wrapping member 33112 forms a “C” structure. The first carrier frame 33111 and the first fixing member 3315 are mounted inside the first wrapping member 33112, and the first carrier frame, the first fixing member, and the first wrapping member are fixed with screws. Further, a first opening 33116 is provided in one side of each first connection through hole 33114. By the arrangement of the first opening 33116, it is more convenient to mount the first transmission gear 3313.

The passive drive assembly 332 includes a second fixed frame 3321 fixed on another side of the transmission base 34 away from the active drive assembly 331, and a driven wheel 3322 arranged on the second fixed frame 3321. The first transmission gear 3313 and the driven wheel 3322 are linked to each other through the foregoing synchronous wheel belt 333 and a passive transmission shaft 3323 provided. The synchronizer members 35 of this embodiment are synchronizer racks, and synchronizer gears 361 that are meshed with the synchronizer members 35 are arranged on two side positions of the drive rod 36.

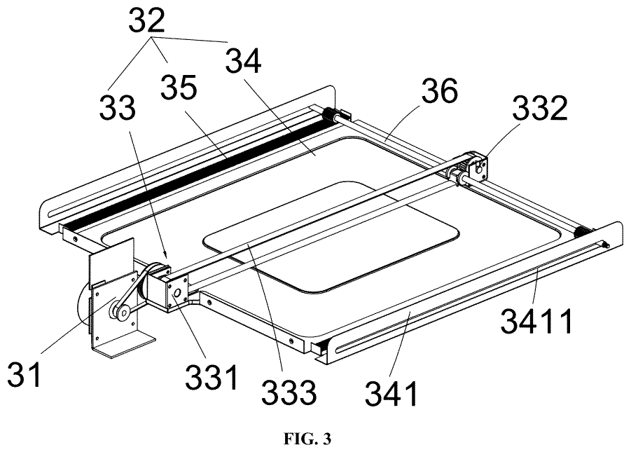

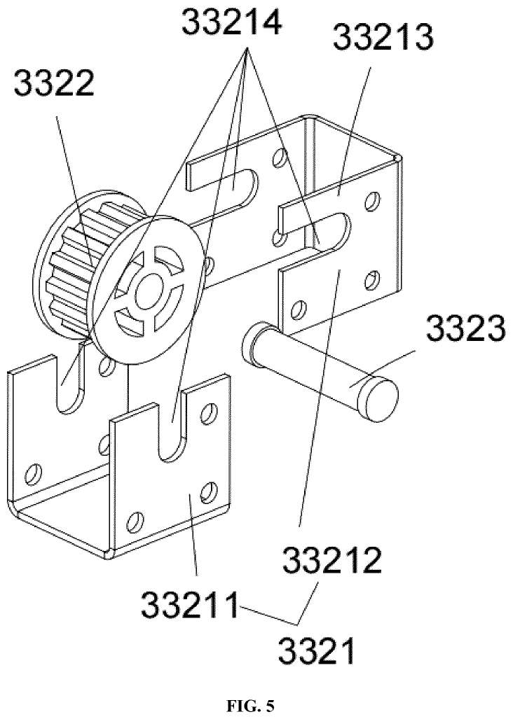

As shown in FIG. 5, in this embodiment, the second fixed frame 3321 includes a first bracket 33211 and a second bracket 33212 that are vertically fastened to each other. The first bracket 33211 and the second bracket 33212 are both provided with two outwards extending connecting edges 33213. Hanging holes 33214 are provided in the connecting edges 33213. A size of the first bracket 33211 is slightly greater than a size of the second bracket 33212, so that the first bracket 33211 and the second bracket 33212 are vertically fastened to each other. The connecting edge 33213 of the first bracket 33211 is upwards vertically arranged. The second bracket 33212 is horizontally arranged to wrap around the first bracket 33211, so that the hanging holes 33214 are vertically stacked with each other to form the passage for allowing the passive transmission shaft 3323 to pass through, as shown in FIG. 3.

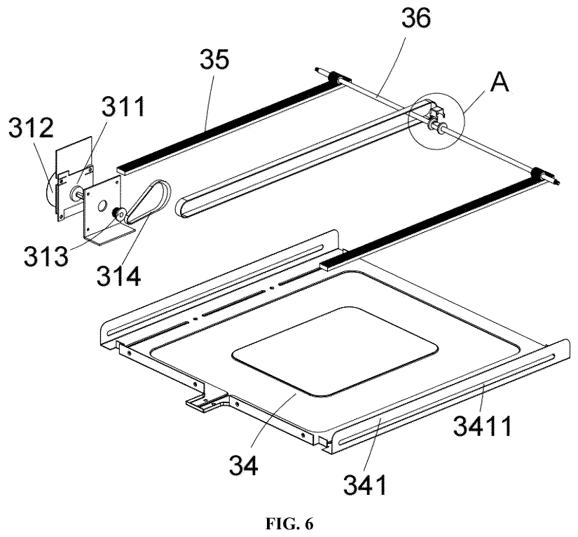

As shown in FIG. 6, the drive module 31 of this embodiment includes a motor fixing frame 311 fixedly connected inside the kitchen appliance body 1, a drive motor 312 fixed on the motor fixing frame 311, and a second transmission gear 313 connected to the drive motor 312. The second transmission gear 313 is connected to the first transmission gear 3313 through a gear belt 314 provided.

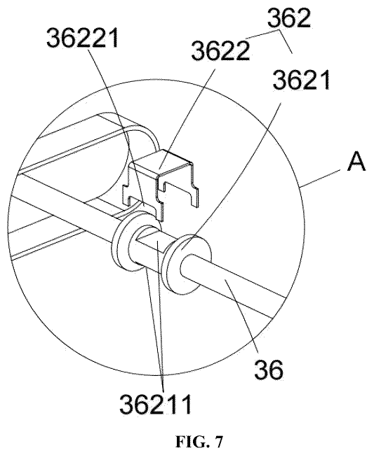

As shown in FIG. 6 and FIG. 7, a fixing assembly 362 is connected to a middle position of the drive rod 36, and the fixing assembly 362 is fixedly connected to the synchronous wheel belt 333. The foregoing fixing assembly 362 includes a second fixing member 3621 and a third fixing member 3622. The second fixing member 3621 is of a cylindrical structure and sleeves a middle position of the drive rod 36. Concave parts 36211 are provided at upper and lower ends of the second fixing member 3621. The third fixing member 3622 is of a frame structure. The third fixing member 3622 is inserted into the concave parts 36211 and is connected to the second fixing member 3621. Inwards sunken clamping slots 36221 are formed in two ends of the third fixing member 3622. The clamping slots 36221 wrap around the synchronous wheel belt 333 to achieve linkage.

In order to ensure driving on the drawer door 23 by the drive rod 36 and the accuracy of movement of the drawer door, a side wing of the transmission base 34 extends upwards to form a limiting portion 341. A semicircular arc groove 3411 is provided in the limiting portion 341. The drive rod 36 passes through the semicircular arc groove 3411 and is connected to the drawer door assembly 2. The door opening and closing structure of the drawer type kitchen appliance further includes a connecting piece 24. Threads are formed in two end portions of the drive rod 36. One end of the connecting piece 24 is connected to the sliding rail support frame 22. Another end of the connecting piece 24 is connected to an end portion of the drive rod 36 through a bolt. Signal acquisition devices are arranged at two end portions of the semicircular arc groove 3411. The signal acquisition devices can be limiting sensors. By the arrangement of the semicircular arc groove 3411, shaking up and down due to an external force during movement of the end portion of the drive rod 36 is avoided, and a travel of movement of the drive rod 36 can be accurately limited, to prevent the drawer door 23 from derailing. By the further arrangement of the signal acquisition devices, when the drive rod 36 reaches a designated position, the signal acquisition devices can provide signals to the drive motor 312, thereby stopping a door opening or closing action.

Brief description of the working principle of the present disclosure: In the present disclosure, when the drawer door 23 needs to be opened, the drive motor 312 is turned on, which sequentially drives the second transmission gear 313 and the main drive gear 3312 to rotate. The first transmission gear 3313 is driven by the main drive gear 3312 to rotate. Next, the first transmission gear 3313 drives the synchronous wheel belt 333 to rotate, and the driven wheel 3322 is arranged on another side of the synchronous wheel belt 333 to assist in the rotation of the synchronous wheel belt 333. The drive rod 36 is fixedly connected to the synchronous wheel belt 333 through the second fixing member 3621 and the third fixing member 3622. Therefore, the drive rod 36 can move forwards with the synchronous wheel belt 333. Especially, the synchronizer gears 361 arranged on the two sides of the drive rod 36 are meshed with the synchronizer members 35, so that the two sides of the drive rod 36 can achieve synchronous movement and avoid desynchronization. Meanwhile, the two end portions of the drive rod 36 drive the drawer door 23 to move outwards along the sliding rail 21 through the connecting piece 24, thus opening the drawer door 23. When the door needs to be closed, only the motor needs to run in an opposite direction.

The above describes the preferred embodiments of the present disclosure and is not intended to limit the present disclosure. Any modification, equivalent replacement, and improvement made within the spirit and scope of the present disclosure shall fall within the protection scope of the present disclosure.

What is claimed is:

1. A door opening and closing structure of a drawer type kitchen appliance, comprising:
a kitchen appliance body (1), wherein the kitchen appliance body (1) is provided with a drawer door assembly (2); and
a drawer movement mechanism (3) that is arranged inside the kitchen appliance body (1) and is connected to the drawer door assembly (2), wherein the drawer movement mechanism (3) comprises a drive module (31) and a transmission module (32); the transmission module (32) comprises a transmission wheel group (33) connected to the drive module (31), a transmission base (34) fixedly arranged inside the kitchen appliance body (1), and two groups of synchronizer members (35) arranged on the transmission base (34); the transmission wheel group (33) is connected with a drive rod (36); two sides of the drive rod (36) are respectively linked with the synchronizer members (35); and two end portions of the drive rod (36) are connected to the drawer door assembly (2), to drive the drawer door assembly (2) to be opened or closed.

2. The door opening and closing structure of the drawer type kitchen appliance according to claim 1, wherein the transmission wheel group (33) comprises an active drive assembly (331), a passive drive assembly (332), and a synchronous wheel belt (333) configured to connect the active drive assembly (331) to the passive drive assembly (332); and the active drive assembly (331) comprises a first fixed frame (3311) fixedly arranged on the transmission base (34), a main drive gear (3312) arranged on one side of the first fixed frame (3311), and a first transmission gear (3313) movably arranged inside the first fixed frame (3311).

3. The door opening and closing structure of the drawer type kitchen appliance according to claim 2, wherein the first transmission gear (3313) and the main drive gear (3312) are linked with each other through a first transmission shaft (3314) provided; the first fixed frame (3311) is further connected with a first fixing member (3315); bearings (3316) are arranged on front and rear sides of the first fixing member (3315); and the first transmission shaft (3314) links the first transmission gear (3313) to the main drive gear (3312) through the two bearings.

4. The door opening and closing structure of the drawer type kitchen appliance according to claim 2, wherein the first transmission gear (3313) is linked to the main drive gear (3312) through a first transmission shaft (3314) provided; the passive drive assembly (332) comprises a second fixed frame (3321) fixed on another side of the transmission base (34) away from the active drive assembly (331), and a driven wheel (3322) arranged on the second fixed frame (3321); and the first transmission gear (3313) and the driven wheel (3322) are linked to each other through the synchronous wheel belt (333) and a passive transmission shaft (3323) provided.

5. The door opening and closing structure of the drawer type kitchen appliance according to claim 2, wherein the drive module (31) comprises a motor fixing frame (311) fixedly connected inside the kitchen appliance body (1), a drive motor (312) fixed on the motor fixing frame (311), and a second transmission gear (313) connected to the drive motor (312); and the second transmission gear (313) is connected to the first transmission gear (3313) through a gear belt (314) provided.

6. The door opening and closing structure of the drawer type kitchen appliance according to claim 2, wherein a fixing assembly (362) is connected to a middle position of the drive rod (36), and the fixing assembly (362) is fixedly connected to the synchronous wheel belt (333).

7. The door opening and closing structure of the drawer type kitchen appliance according to claim 6, wherein the fixing assembly (362) comprises a second fixing member (3621) and a third fixing member (3622); the second fixing member (3621) is of a cylindrical structure and sleeves a middle position of the drive rod (36); concave parts (36211) are provided at upper and lower ends of the second fixing member (3621); the third fixing member (3622) is of a frame structure; the third fixing member (3622) is inserted into the concave parts (36211) and is connected to the second fixing member (3621); inwards sunken clamping slots (36221) are formed in two ends of the third fixing member (3622); and the clamping slots (36221) wrap around the synchronous wheel belt (333) to achieve linkage.

8. The door opening and closing structure of the drawer type kitchen appliance according to claim 2, wherein the synchronizer members (35) are synchronizer racks, and synchronizer gears (361) that are meshed with the synchronizer members are arranged on two side positions of the drive rod (36).

9. The door opening and closing structure of the drawer type kitchen appliance according to claim 4, wherein a side wing of the transmission base (34) extends upwards to form a limiting portion (341); a semicircular arc groove (3411) is provided in the limiting portion (341); and the drive rod (36) passes through the semicircular arc groove (3411) and is connected to the drawer door assembly (2).

10. The door opening and closing structure of the drawer type kitchen appliance according to claim 9, wherein the drawer door assembly (2) comprises a sliding rail (21) fixedly arranged inside the kitchen appliance body (1), a sliding rail support frame (22) connected to the sliding rail (21), and the drawer door (23) connected to the sliding rail support frame (22).

11. The door opening and closing structure of the drawer type kitchen appliance according to claim 10, further comprising a connecting piece (24), wherein threads are formed in two end portions of the drive rod (36); one end of the connecting piece (24) is connected to the sliding rail support frame (22); and another end of the connecting piece (24) is connected to an end portion of the drive rod (36) through a bolt.

12. The door opening and closing structure of the drawer type kitchen appliance according to claim 9, wherein signal acquisition devices are arranged at two end portions of the semicircular arc groove (3411).

13. The door opening and closing structure of the drawer type kitchen appliance according to claim 12, wherein the signal acquisition devices are limiting sensors.

14. The door opening and closing structure of the drawer type kitchen appliance according to claim 3, wherein the first fixed frame (3311) comprises a first carrier frame (33111) and a first wrapping member (33112); a first accommodating space (33113) for accommodating the first transmission gear (3313) is formed on the first carrier frame (33111); first connecting through holes (33114) are provided in front and rear ends of the first carrier frame (33111); the first connecting through holes (33114) are configured to allow the first transmission shaft (3314) to pass through; and the first carrier frame (33111) and the first fixing member (3315) are mounted inside the first wrapping member (33112) and fixed with screws.

15. The door opening and closing structure of the drawer type kitchen appliance according to claim 14, wherein wrapping edges (33115) are formed on two sides of the first wrapping member (33112), so that the first wrapping member (33112) forms a “C” structure.

16. The door opening and closing structure of the drawer type kitchen appliance according to claim 14, wherein a first opening (33116) is provided in one side of each first connection through hole (33114).

17. The door opening and closing structure of the drawer type kitchen appliance according to claim 15, wherein a first opening (33116) is provided in one side of each first connection through hole (33114).

18. The door opening and closing structure of the drawer type kitchen appliance according to claim 4, wherein the second fixed frame (3321) comprises a first bracket (33211) and a second bracket (33212) that are vertically fastened to each other, and the first bracket (33211) and second bracket (33212) form a passage for allowing the passive transmission shaft (3323) to pass through after being vertically fastened to each other.

19. The door opening and closing structure of the drawer type kitchen appliance according to claim 18, wherein a size of the first bracket (33211) is slightly greater than a size of the second bracket (33212).

20. The door opening and closing structure of the drawer type kitchen appliance according to claim 18, wherein the first bracket (33211) and the second bracket (33212) are both provided with two outwards extending connecting edges (33213); hanging holes (33214) are provided in the connecting edges (33213); the connecting edge (33213) of the first bracket (33211) is upwards vertically arranged; and the second bracket (33212) is horizontally arranged to wrap around the first bracket (33211), so that the hanging holes (33214) are vertically stacked with each other to form the passage for allowing the passive transmission shaft (3323) to pass through.
